(19) United States
(12) Patent Application Publication
(10) Pub. No.: US 2006/0290701 A1
(43) Pub. Date: Dec. 28, 2006

(54) Display unit, method for identifying manufacture number, and method for registering manufacture number

(75) Inventor: Osamu Masaki, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/271,949

(22) Filed: Nov. 14, 2005

(30) Foreign Application Priority Data
Jun. 28, 2005 (JP) 2005-187918

(51) Int. Cl. G06F 13/14; G09G 5/39

(52) U.S. Cl. 345/520; 345/531

(57) ABSTRACT

A display unit includes a main body section including an image display device; a memory section for storing a manufacture number assigned to the image display device; an I/F section provided with a terminal part for inputting and outputting data from and to an external device; a control section for controlling respective parts of the apparatus and reading out the manufacture number assigned to the image display device in accordance with a readout request to display the manufacture number on an image display surface of the image display device; a remote controller for operating the apparatus by remote control; and a light-receiving section for receiving a remote-controlled signal light transmitted from the remote controller.

The present application is based on Japanese patent application No. 2005-187918, the entire contents of which are incorporated herein by reference.

### BACKGROUND OF THE INVENTION

1. Field of the Invention

The present invention relates to a display unit used for television apparatuses (hereinafter referred to as “TV apparatus”) and the like, a method for identifying a manufacture number, and a method for registering the manufacture number, and particularly to a display unit, and a method for identifying a manufacture number of the display unit without disassembling the display unit, and a method for registering the manufacture number wherein the manufacture number is identified.

2. Description of the Related Art

Present-day electronics device is composed of a plurality of parts wherein it is difficult to manufacture the quite same parts in terms of shape, and performance, even if they are the same parts, so far as these parts are industrial products. In the same parts, there is a case where a slight individual difference appears in these parts due to, for example, different production lots. Under the circumstance, an article of manufacture is manufactured from parts each of which is within an allowance which has been previously determined so as to satisfy a certain quality as a finished product.

In recent years, outstanding convenience is realized with development in multifunctionality and high performance of electronics devices, and further achievement of advanced electronic control. On the other hand, there is such a case where a problem which could not figure out at the time of design or manufacturing is found as a result of practical use. Thus, it is intended to restore electronics devices by applying procedures for failure diagnosis of the electronics devices, updating for software, and the like procedures as after-sales service so as not to put end-users at disadvantages.

For the purpose of applying adequately such after-sales service, there is proposed a repair service system wherein a service personnel accesses to a data base provided in a CATV center through a customer's TV apparatus to specify the apparatus to be repaired, whereby repair service information corresponding to the apparatus is obtained by the service personnel (for example, see Japanese Patent No. 3551203[0024] to [0054]).

According to Japanese Patent No. 3551203, however, even if a defective can be specified, parts of the defective cannot be identified, so that there is such a problem that an appropriate treatment cannot be applied to the parts in spite of existence of an inherent problem involved in the parts in question.

For instance, although liquid crystal panels manufactured precisely by an advanced technique are used in liquid crystal displays taken principally in TV apparatuses and the like in late years, it is difficult to bring completely color reproducibility in every liquid crystal panel into line with each other. Accordingly, display control is made in such that proper gamma data is applied to every liquid crystal panel so as to obtain color reproducibility having a certain quality.

Such problem as described above is not only concerned with liquid crystal panels, but it is the same as that in plasma display panel (PDP), and surface-conduction electron-emitter devices which are expected in future propagation. Therefore, it is important to be capable of promptly complying with a problem without accompanying major operations such as exchange of parts and the like.

As information for identifying parts, there is a manufacture number. In this respect, however, the manufacture number must be directly confirmed after disassembling an apparatus from the parts in question, when a failure or the like happens, and hence, undesirable time and effort are required for disassembling the apparatus, so that the confirmation of such manufacture number cannot be made easily.

Accordingly, objects of the present invention is to provide a display unit by which a manufacture number assigned part can be confirmed easily without disassembling electronics devices, a method for identifying the manufacture number, and a method for registering the manufacture number.

### SUMMARY OF THE INVENTION

For the sake of achieving the above-described objects, the present invention is constituted as described hereinafter.

According to the present invention, a display unit may comprise a memory section for storing a manufacture number assigned part constituting an apparatus; and a display section for displaying visually the manufacture number read out from the memory section in accordance with a readout request.

According to the present invention, a display unit may comprise a main body section including an image display device; a memory section for storing a manufacture number assigned to the image display device; an I/F section provided with a terminal part for inputting and outputting data from and to an external device; a control section for controlling respective parts of the apparatus and reading out the manufacture number assigned to the image display device in accordance with a readout request to display the manufacture number on an image display surface of the image display device; and a light-receiving section for receiving a remote-controlled signal light including the readout request transmitted from a remote controller.

The memory section may store the manufacture number based on optical scanning of a label on which the manufacture number to be assigned to the part is recorded.

The memory section may store the manufacture number based on optical scanning of a label on which the manufacture number to be assigned to the image display device is recorded.

The memory section may store the manufacture number which is read out from a manufacture number-storing section of the part in fitting the part to the apparatus.

The memory section may store the manufacture number which is read out from the image display device in fitting the part to the apparatus.

The display section may display visually the manufacture number read out from the memory section in accordance with a remote control signal from a remote controller.

The display section may display visually the manufacture number read out from the image display device in accordance with a remote control signal from the remote controller.

The memory section may output the manufacture number in accordance with a readout request from an external device connected to the apparatus.

According to the present invention, a method for identifying a manufacture number of a display unit may comprise the steps of storing a manufacture number assigned part constituting an apparatus in a memory section; reading out the manufacture number from the memory section in accordance with a readout request; and displaying visually the manufacture number read out from the memory section on a display section.

According to the present invention, a method for identifying a manufacture number of a display unit may comprise the steps of storing a manufacture number assigned part constituting an apparatus in a memory section; reading out the manufacture number from the memory section in accordance with a readout request; and outputting the manufacture number read out from the memory section to an external device connected to the apparatus.

The step for storing the manufacture number in the memory section may be executed prior to fitting of the part to the apparatus.

The step for reading out the manufacture number from the memory section may be executed in a service mode of the apparatus.

According to the present invention, a method for registering a manufacture number of a display unit may comprise the steps of fitting a part to an apparatus; reading out a manufacture number from the part fitted to the apparatus; and storing the manufacture number read out in a memory section of the apparatus.

Therefore, a manufacture number assigned part can be easily identified without disassembling electronics devices containing such parts in accordance with the present invention.

### BRIEF DESCRIPTION OF THE DRAWINGS

The present invention will be explained in more detail in conjunction with appended drawings, wherein:

FIG. 1 is a perspective view showing the whole structure of a TV apparatus as a display unit according to a first embodiment of the present invention;

FIG. 2 is a block diagram showing a circuit of the TV apparatus according to the first embodiment of the invention;

FIG. 3 is a view illustrating optical scanning of a manufacture number in an image display device;

FIG. 4 is a block diagram illustrating processes for outputting the manufacture number assigned to the image display device stored in a memory section;

FIGS. 5A and 5B are views each showing an image displayed on an image display surface of the image display device wherein FIG. 5A shows an initial image in a service mode, while FIG. 5B shows an image of the manufacture number displayed visually in the service mode;

FIG. 6 is a diagram showing partially service data provided relating to an image display device;

FIG. 7 is a flowchart illustrating a method for identifying a manufacture number in a service mode;

FIG. 8 is a perspective view showing the whole structure of a TV apparatus as a display unit according to a second embodiment of the invention;

FIG. 9 is a block diagram illustrating a constitution for registering a manufacture number assigned to an image display device to a memory section; and

FIG. 10 is a flowchart illustrating procedures for registering the manufacture number assigned to the image display device to the memory section.

### DESCRIPTION OF THE PREFERRED EMBODIMENTS

Preferred embodiments of the present invention will be described hereinafter by referring to the accompanying drawings.

### First Embodiment

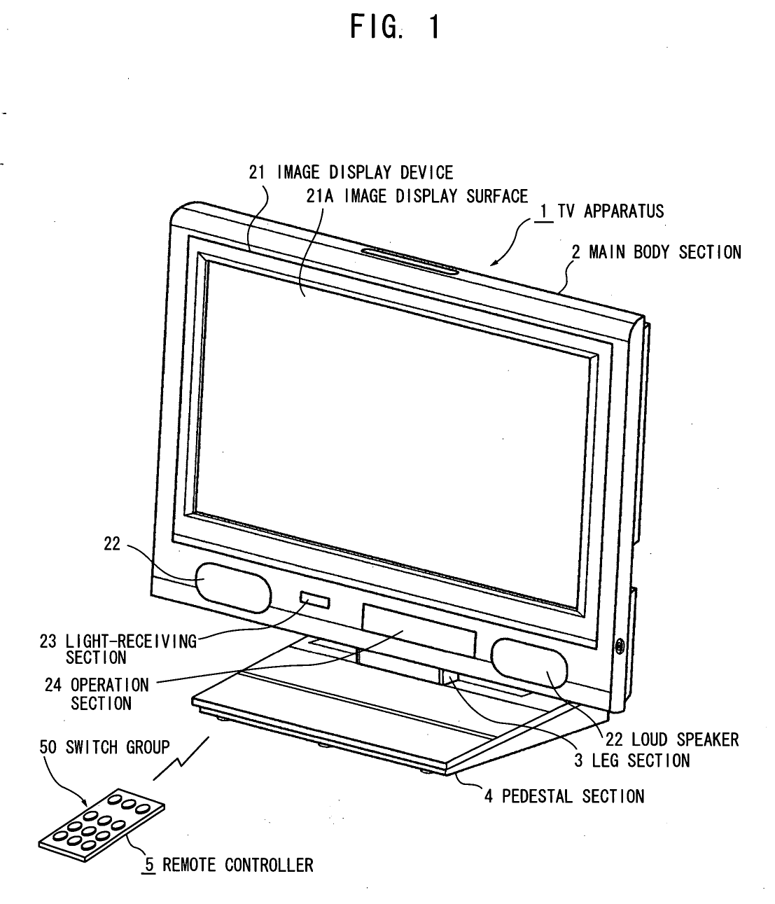

FIG. 1 is a perspective view showing the whole construction of a TV apparatus as a display unit according to the first embodiment of the invention.

(Constitution of TV Apparatus 1)

The TV apparatus 1 is composed of a main body section 2, a leg section 3 for supporting the main body section 2, a pedestal section 4 on which the leg section 3 is provided, and a remote controller 5 for operating the TV apparatus 1 by remote control.

The main body section 2 has such a structure that an image display surface 21A of an image display device 21 composed of, for example, an SED, a liquid crystal panel or the like is arranged so as to constitute a front of the main body 2, and the image display surface 21A is arranged so as to be arbitrarily variable an angle of elevation around the leg section 3 as its fulcrum.

Furthermore, the TV apparatus 1 is provided with loud speakers 22, 22 on the lower part of the image display device 21, a light-receiving section 23 for receiving a remote-controlled signal light transmitted from the remote controller 5, and an operation section 24 including switches of adjusting an image quality in the image display device 21 and a terminal part for inputting and outputting data, a front of the operation section 24 being protected by an openable cover.

The remote controller 5 involves a thin plate-like main body surface on which a switch group composed of a power-on switch for the TV apparatus, channel section switches, and a variety of function switches for calling out the other functions involved in the TV apparatus 1, and a remote-controlled signal light transmits to the light-receiving section 23 provided on the main body section 2 from a light-emitting section (not shown) in accordance with operations of the switch group 50.

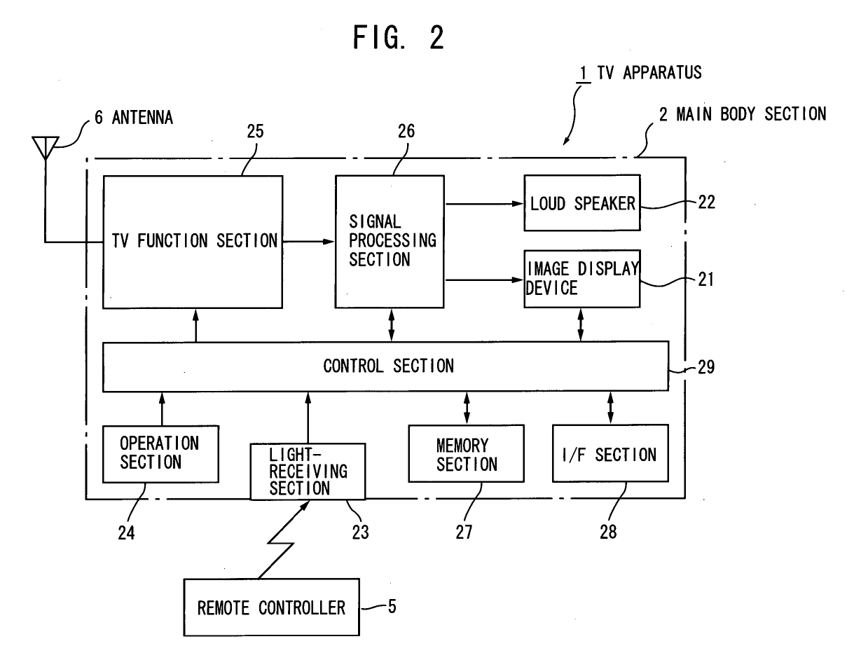

FIG. 2 is a block diagram showing a circuit of the TV apparatus according to the first embodiment of the invention wherein the TV apparatus 1 includes a television function section 25 for receiving a signal of channel selected through an antenna 6, a signal processing section 26 for taking out image signals and audio signals from output signals of the television function section 25, the loud speakers 22, 22 for outputting audios based on audio signals output from the signal processing section 26, the image display device 21 for displaying images based on image signals output from the signal processing section 26, the memory section 27 for storing a manufacture number assigned to the image display device 21, an I/F section 28 provided with the terminal part for inputting and outputting data used for connecting peripheral equipment to the TV apparatus 1, and a control section 29 for reading out the manufacture number assigned to the image display device 21 from the memory section 27 in accordance with a read-out request to display the resulting manufacture number on the image display surface 21A in addition to control the respective sections of the TV apparatus 1.

The memory section 27 is a hard disk drive (HDD) or a flash memory for storing manufacture numbers of parts constituting the TV apparatus 1 wherein when a read-out request as to a part is received from the control section 29 in a service mode, the manufacture number assigned to the part requested is output. In the present embodiment, a manufacture number assigned to the image display device 21 is stored in the memory section 27 as a part.

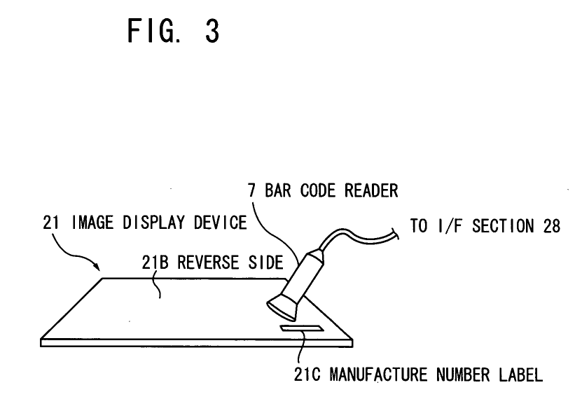

FIG. 3 is a view illustrating optical scanning of a manufacture number in an image display device wherein for example, a manufacture number label 21C pasted on the reverse side 21B of the image display device 21 is scanned optically by means of a bar code reader 7 for storing the manufacture number assigned to the image display device 21 in the memory section 27. The bar code reader 7 is connected to the I/F section 28, and the control section 29 stores data of the manufacture number input from the I/F section 28 in the memory section 27.

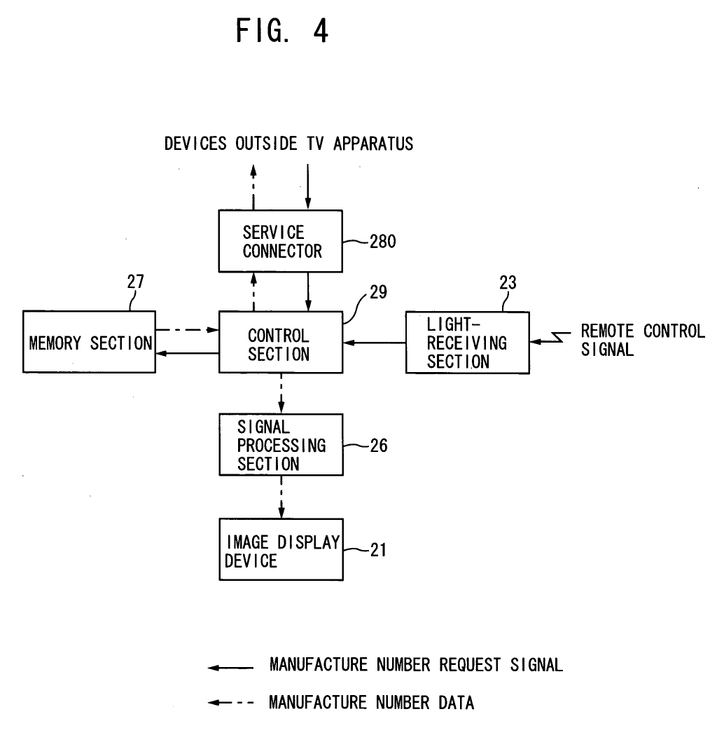

FIG. 4 is a block diagram illustrating processes for outputting the manufacture number assigned to the image display device stored in the memory section.

In the first embodiment, an outputting manner of a manufacture number includes a visual display of the manufacture number on an image display device 21 in a service mode, and outputting data to the external devices of the TV apparatus 1 from a connecter for service use 280 provided on the I/F section in a service mode.

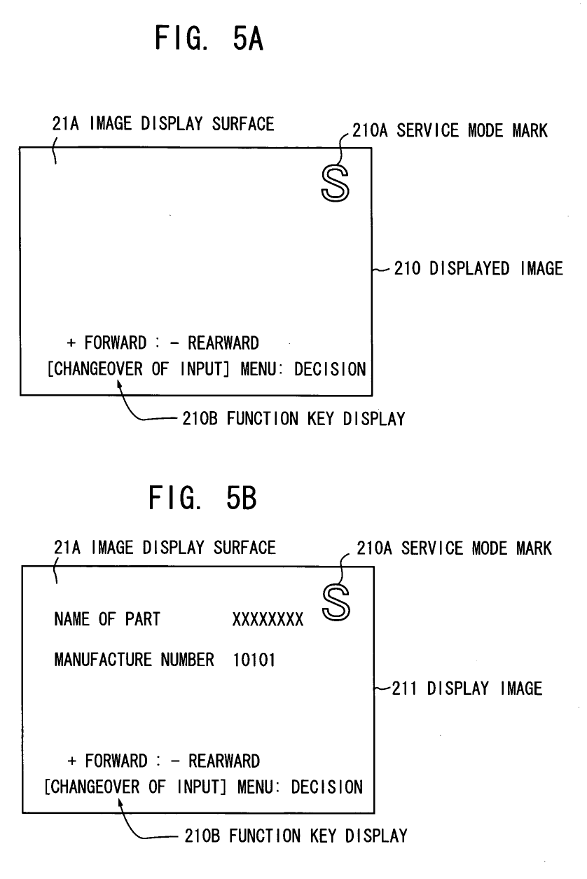

FIGS. 5A and 5B are views each showing an image displayed on an image display surface of the image display device wherein FIG. 5A shows an initial image in a service mode, while FIG. 5B shows an image of the manufacture number displayed visually in the service mode.

A service mode is displayed, for example, when service personnel operates the switch group 50 in the remote controller 5 to select a service mode at customer's site. When the service mode is selected, a displayed image 210 including a service mode mark “S” 210A on the upper right corner on the image display surface 21A as shown in FIG. 5A.

In FIGS. 5A and 5B, function key display 210B of “+: Forward”, “−: Rearward”, “[Changeover of Input]: Menu”, and “Decision” is also shown wherein representations “+, −, [Changeover of Input], and “Decision” correspond to switches provided on the switch group 50.

FIG. 5B shows an image of a manufacture number displayed, when a manufacture number assigned part designated in the menu is selected. In the service mode, when there is a request for displaying a manufacture number assigned to the image display device 21, a display image 211 containing a name of a part and the manufacture number thereof are displayed in addition to the images displayed on the image display surface 21A shown in FIG. 5A. In this case, although the number of five digits is shown as a manufacture number, it is merely illustrative, and any type of formats in manufacture numbers composed of alphabets, symbols, and numerals may be applied.

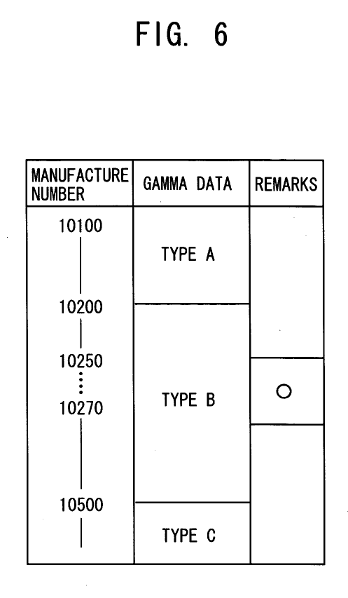

FIG. 6 is a diagram showing partially service data provided relating to an image display device.

The service data displayed is obtained, for example, by service personnel through Internet with accessing a home page of a maker supplying an image display device in question, and downloading the service data relating thereto. In this case, the service data indicates types of gamma data (type A, type B, or type C) to be applied in response to a manufacture number assigned to the image display device 21, and further a part of parts to be exchanged is indicated by “o” as remark information.

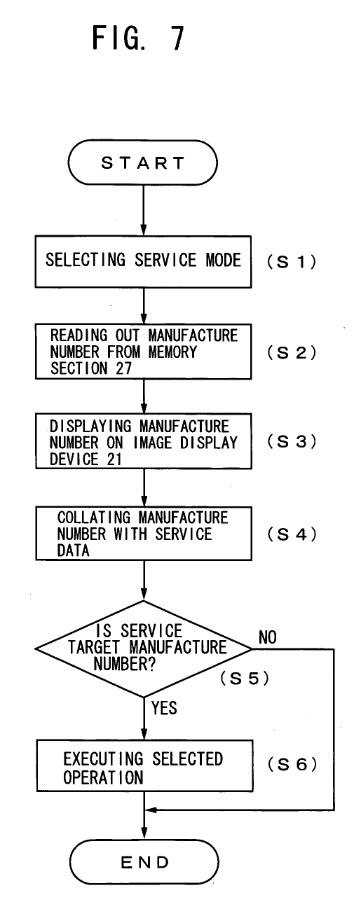

FIG. 7 is a flowchart illustrating a method for identifying a manufacturer's manufacture number in a service mode.

In the following, a method for identifying manufacture numbers according to the first embodiment will be described by referring to FIG. 7 together with FIGS. 1 through 6.

First, service personnel operates the switch group 50 in the remote controller 5 at a customer's site to select a service mode (S1).

The remote controller 5 transmits a remote-controlled signal light in response to a selection signal in the service mode to the light-receiving section 23. The light-receiving section 23 of the main body section 23 outputs the selection signal in the service mode in accordance with the remote-controlled signal light received to the control section 29. When the selection signal in the service mode is received by the control section 29, the control section 29 controls the signal processing section 26 so as to display the displayed image 210 shown in FIG. 5A.

Under the circumstances, when the service personnel operates the remote controller 5 so as to display a manufacture number assigned to the image display device 21 on the basis of the function key display 210B shown in FIG. 5A, a display request signal light of the manufacture number is transmitted to the light-receiving section 23. The light-receiving section 23 of the main body section 2 outputs a display request signal of the manufacture number in accordance with the display request signal light received to the control section 29. When the display request signal is received, the control section 29 reads out a manufacture number assigned to the image display device 21 from the memory section 27 (S2), and the control section 29 controls the signal processing section 26 so as to display the displayed image 211 containing a name of the part and the manufacture number as shown in FIG. 5B (S3).

The service personnel collates the manufacture number displayed in the display image 211 with the service data shown in FIG. 6 (S4).

When it is found that the image display device 21 in question corresponds to a device being a service target required for updating gamma data from the manufacture number checked up (S5: YES), the service personnel operates the remote controller 5 to make satellite download of gamma data updated to be applied to the TV apparatus 1, and installs the gamma data downloaded (S6).

More specifically, when it is assumed that a manufacture number assigned to the image display device 21 read out from the memory section 27 is “10200”, such operating instructions that gamma data of type B is to be applied as a result of collation of the service data shown in FIG. 6 are specified clearly. In this case, when the gamma data of type B is satellite-downloaded to install the data updated, the optimum gamma data of type B is applied to the objective image display device 21.

On one hand, when the image display device 21 is not a service object requiring updating of gamma data (S5: NO), the service personnel makes a failure diagnosis on parts other than the image display device 21.

### Advantageous Effects of the First Embodiment

According to the above-described first embodiment, the manufacture number assigned to the image display device 21 constituting the TV apparatus 1 has been stored in the memory section 27, and the manufacture number is read out from the memory section 27 in accordance with a read-out request to display visually the manufacture number on the image display device 21. Accordingly, a labor hour and an operation for identifying a manufacture number can be saved, when a trouble arises in the image display device 21 without disassembling the TV apparatus 1 for identification of the image display device's manufacture number. Besides, a rapid judgment for pertinent advisability, or a rapid maintenance work can be made.

An SED mentioned as an example of the image display device 21 has a thin structure composed of a glass substrate provided with electron-releasing sections in response to pixel numbers is disposed closely to another glass substrate on which picture elements are formed by coating a fluorescent material, and a spacing defined between these glass substrates is sealed evacuatedly. The SED has advantages in response, color reproducibility, wide field of view, wide screen, low power consumption and the like.

The present invention brings about particularly effects after-sales service in the image display device 21, so that color picture quality in a wide screen desired by a customer may be provided for a long period of time.

Since a part in question can be easily specified due to visual indication of a manufacture number, it is possible, for example, to comply with a problem found in the part in its manufacturing step without delay in addition to a trouble of the TV apparatus 1.

In the first embodiment, although such constitution that a manufacture number assigned to the image display device 21 as a part is stored in the memory section 27, and the manufacture number is read out in response to a read-out request is described, it may be in such that a manufacture number assigned part other than the image display device 21 is read and input by means of either the above-mentioned bar code reader, or an input means such as keyboard and the like to store the manufacture number in the memory section, while the manufacture number is read out in response to a read-out request to visually display the manufacture number.

Furthermore, although such constitution that a manufacture number is visually displayed on the image display device 21 of the TV apparatus 1 is described in the first embodiment, it is also possible to output externally the manufacture number in accordance with read-out request from a device outside the TV apparatus 1.

In this case, when a signal for requesting to search the manufacture number is input to the control section 29 from a device outside the TV apparatus 1 through a service connector 280 shown in FIG. 4, the control section 29 reads out the manufacture number assigned part in response to the signal for requesting to search the manufacture number from the memory section 27 and outputs the manufacture number thus searched to the device outside the TV apparatus 1 through the service connector 280.

According to the manner as described above, for example, when a service personnel connects his (or her) terminal equipment such as a PC to the service connector 280, a manufacture number assigned part in question can be easily and promptly obtained, even if visual display of the manufacture number cannot be made on a display surface of the image display device 21 due to a trouble thereof, and thus, troublesome operation such as disassembly of the TV apparatus 1 can be avoided.

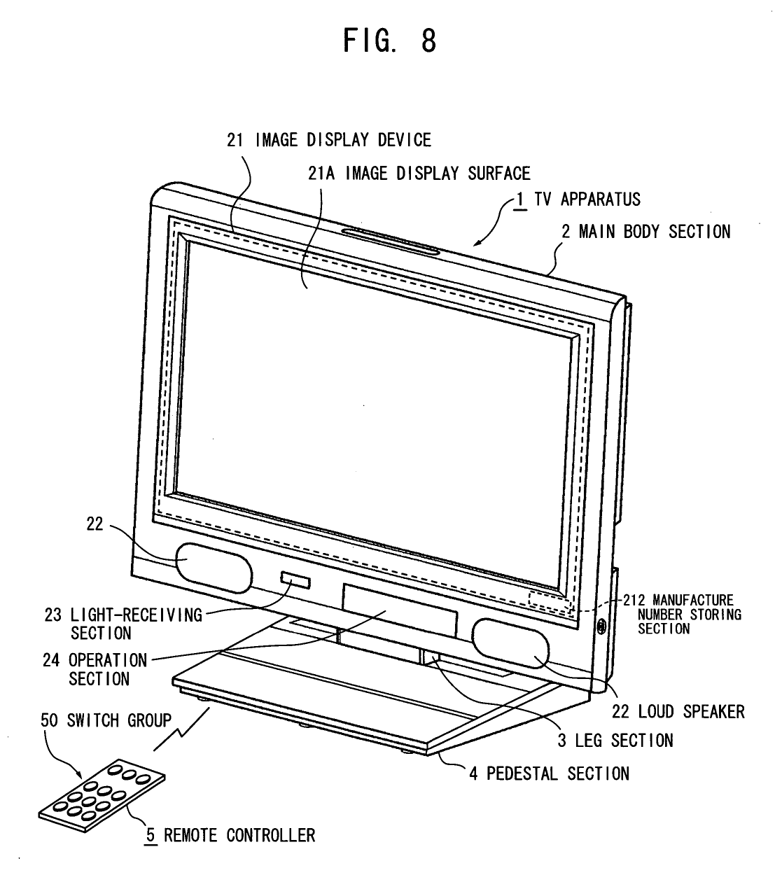

FIG. 8 is a perspective view showing the whole structure of a TV apparatus as a display unit according to a second embodiment of the invention wherein components having the same constitutions and functions as that of the first embodiment are designated by the same reference numerals as those of the first embodiment.

(Constitution of TV Apparatus 1)

The second embodiment differs from that of the first embodiment in that an image display device 21 of the TV apparatus 1 is provided with a manufacture number storage section 212 for storing the manufacture number assigned to the image display device 21. The manufacture number storage section 212 is made of, for example, an incorporable semiconductor memory into the image display device 21.

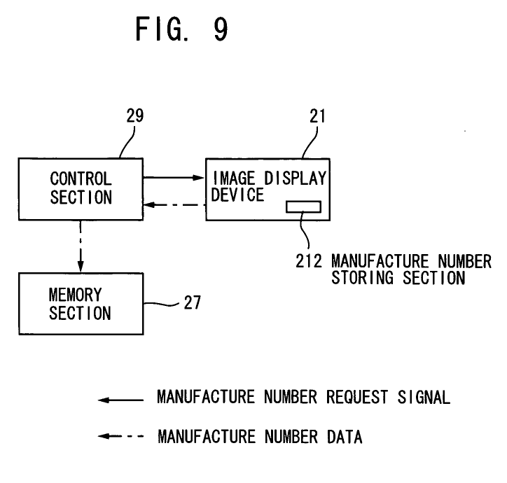

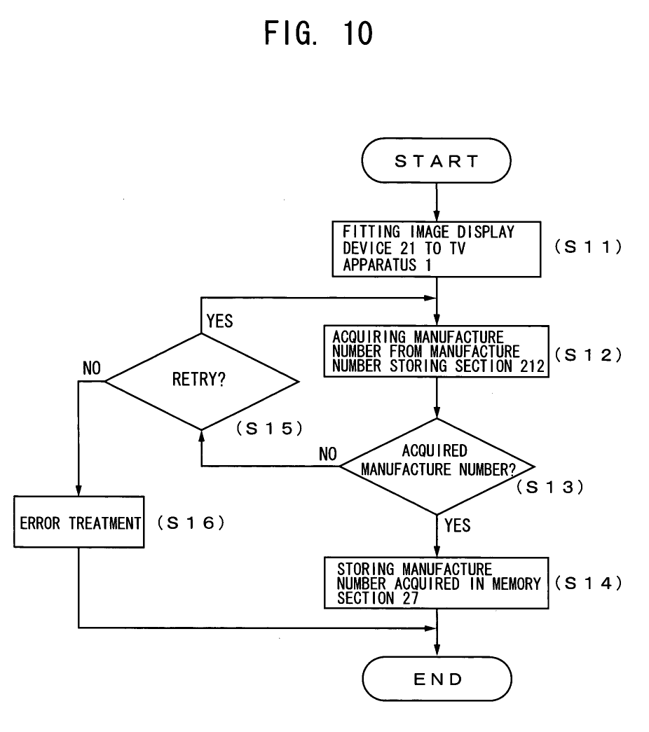

FIG. 9 is a block diagram illustrating a constitution for registering a manufacture number assigned to an image display device to a memory section, and FIG. 10 is a flowchart illustrating procedures for registering the manufacture number assigned to the image display device to the memory section.

In the following, a method for registering a manufacture number will be described by referring to the flowchart wherein the procedures for registering a manufacture number assigned to an image display device fitted to a TV apparatus in its manufacturing line are described.

In the manufacturing line of TV apparatuses, when an operator fits the image display device 21 to the TV apparatus 1 (S11), a control section 29 outputs a manufacture number request signal with respect to the image display device 21. Based on the manufacture number request signal, the image display device 21 transmits the manufacture number stored in the manufacture number storage section 212 to the control section 29, and the manufacture number transmitted is received by the control section 29 (S12). When the manufacture number is correctly acquired by the control section 29 (S13: YES), and then, the control section 29 is allowed the manufacture number to store in a memory section 27 (S14). If a manufacture number cannot be received by the control section 29 within a certain period of time, the control section transmits (retries) a manufacture number request signal to the image display device 21 over predetermined times (S15). When the control section 29 cannot receive such manufacture number even after repeating a retry, the control section 29 executes an error treatment (S16). The error treatment may be made by, for example, an acoustic output such as beep sound and the like, or an optical output such as blinking indication of an LED lamp and the like due to which an operator is notified of such fact that no manufacture number cannot be received by the control section 29.

### Advantageous Effects of the Second Embodiment

According to the above-described second embodiment, since a manufacture number assigned to the image display device 21 can be registered to the memory section 27 by fitting the image display device 21 to the TV apparatus 1, a labor hour required for implementing optical readout in its manufacturing line can be saved in addition to the desirable effects of the first embodiment.

Moreover, since a manufacture number has been registered, confirmation of connections in parts and judgment of good or wrong in parts can be easily made.

According to the method for registering the manufacture number assigned to the image display device 21 mentioned in the present embodiment, early recognition and treatment of initial failure and updating gamma data or the other software may be made in appropriate manners with reference to not only SEDs or liquid crystal panels, but also more expensive plasma display panels, or CRTs (cathode ray tube), whereby it may be prevented from putting end users at a disadvantage of a burden of repair expense and the like.

It is to be noted that the part is not limited also to the image display device 21 in the second embodiment, but the invention is applicable to the other parts as a matter of course.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

What is claimed is:

1. A display unit, comprising:
a memory section for storing a manufacture number assigned to parts constituting an apparatus; and
a display section for displaying visually the manufacture number read out from the memory section in accordance with a readout request.

2. A display unit, comprising:
a main body section including an image display device;
a memory section for storing a manufacture number assigned to the image display device;
an I/F section provided with a terminal part for inputting and outputting data from and to an external device;
a control section for controlling respective parts of the apparatus and reading out the manufacture number assigned to the image display device in accordance with a readout request to display the manufacture number on an image display surface of the image display device; and
a light-receiving section for receiving a remote-controlled signal light including the readout request transmitted from a remote controller.

3. The display unit as defined in claim 1, wherein:
the memory section stores the manufacture number based on optical scanning of a label on which the manufacture number to be assigned to the part is recorded.

4. The display unit as defined in claim 2, wherein:
the memory section stores the manufacture number based on optical scanning of a label on which the manufacture number to be assigned to the image display device is recorded.

5. The display unit as defined in claim 1, wherein:
the memory section stores the manufacture number which is read out from a manufacture number-storing section of the part in fitting the part to the apparatus.

6. The display unit as defined in claim 2, wherein:
the memory section stores the manufacture number which is read out from the image display device in fitting the part to the apparatus.

7. The display unit as defined in claim 1, wherein:
the display section displays visually the manufacture number read out from the memory section in accordance with a remote control signal from a remote controller.

8. The display unit as defined in claim 2, wherein:
the display section displays visually the manufacture number read out from the image display device in accordance with a remote control signal from the remote controller.

9. The display unit as defined in claim 1, wherein:
the memory section outputs the manufacture number in accordance with a readout request from an external device connected to the apparatus.

10. The display unit as defined in claim 2, wherein:
the memory section outputs the manufacture number in accordance with a readout request from an external device connected to the apparatus.

11. A method for identifying a manufacture number of a display unit, comprising the steps of:
storing a manufacture number assigned part constituting an apparatus in a memory section;
reading out the manufacture number from the memory section in accordance with a readout request; and
displaying visually the manufacture number read out from the memory section on a display section.

12. A method for identifying a manufacture number of a display unit, comprising the steps of:
storing a manufacture number assigned part constituting an apparatus in a memory section;
reading out the manufacture number from the memory section in accordance with a readout request; and
outputting the manufacture number read out from the memory section to an external device connected to the apparatus.

13. The method for identifying a manufacture number of a display unit as defined in claim 11, wherein:
the step for storing the manufacture number in the memory section is executed prior to fitting of the part to the apparatus.

14. The method for identifying a manufacture number of a display unit as defined in claim 12, wherein:
the step for storing the manufacture number in the memory section is executed prior to fitting of the part to the apparatus.

15. The method for identifying a manufacture number of a display unit as defined in claim 11, wherein:
the step for reading out the manufacture number from the memory section is executed in a service mode of the apparatus.

16. The method for identifying a manufacture number of a display unit as defined in claim 12, wherein:
the step for reading out the manufacture number from the memory section is executed in a service mode of the apparatus.

17. A method for registering a manufacture number of a display unit, comprising the steps of:
fitting a part to an apparatus;
reading out a manufacture number from the part fitted to the apparatus; and
storing the manufacture number read out in a memory section of the apparatus.
